(19) United States
(12) Patent Application Publication
(10) Pub. No.: US 2015/0101475 A1
(43) Pub. Date: Apr. 16, 2015

(54) Method of Instrument Simulation

(71) Applicant: SICK AG, Waldkirch (DE)

(72) Inventors: Jurgen CONVENT, Waldkirch (DE); Martin BEHA, Denzlingen (DE); Jochen WUST, Denzlingen (DE)

(21) Appl. No.: 14/514,424

(22) Filed: Oct. 15, 2014

(30) Foreign Application Priority Data
Oct. 16, 2013 (EP) 13188866.1

(51) Int. Cl. G10H 7/00

(52) U.S. Cl. CPC G10H 7/002
USPC 84/609

(57) ABSTRACT

The invention relates to a method of offline instrument simulation of a field instrument, wherein at least one parameter of the field instrument is visualized and a parameterization of the field instrument is made possible and the instrument simulation is generated on the basis of an instrument description file, and wherein the instrument simulation is performed in a browser.

The present invention relates to a method of offline instrument simulation of a field instrument, wherein at least one parameter of the field instrument is visualized and a parameterization of the field instrument is made possible.

The invention in particular relates to field instruments of process automation, that is, for example, transmitters, in particular O₂ transmitters, field instruments for flue gas analysis such as particle measuring instruments, laser scanners and the like. Such field instruments frequently have an integrated web server via which the field instrument can be configured and/or parameterized.

In known solutions, a permanent data connection to the field instrument is necessary for the connection to the web server for the purpose of parameterizing the field instrument, with a permanent data connection, however, not being able to be realized in certain operating environments.

In this connection, DE 10 2007 062 395 A1 and DE 10 2009 054 901 A1 describe the parameterization of a field instrument, wherein instrument software is downloaded from the field instrument and a user interface is generated from the instrument software of the field instrument for parameterizing the field instrument. After the generation of the user interface, the data connection to the field instrument can be interrupted, with the data connection being set up again by means of the user interface after the parameterization of the field instrument to transfer the set parameters to the field instrument. A data connection is thus necessary on the initialization of the user interface and on the transfer of the set parameters. It is therefore also not possible to dispense with a data connection to the field instrument here. DE 10 2011 007 384 A1 furthermore describes that a parameterization is made possible by means of an internet connection to server devices. The known processes accordingly do not work offline.

It is therefore an underlying object of the invention to provide a method of offline instrument simulation of a field instrument which manages completely without any data connection to the field instrument.

In accordance with the invention, this object is satisfied by a method in accordance with claim 1 and in particular in that the instrument simulation is performed in a browser and the instrument simulation is generated on the basis of an instrument description file.

This in particular means that the instrument simulation in a method in accordance with the invention utilizes a user surface which can be displayed and/or changed in a browser. The instrument simulation is thus in particular based solely on web technologies. The installation of additional software for performing the instrument simulation can therefore be dispensed with since the instrument simulation uses a browser for its performance which is anyway available on almost every computer. The instrument simulation in this respect in particular also makes possible the offline configuration, i.e. the parameterization of the simulated field instrument.

The instrument description file which forms the basis for the instrument simulation can in this respect e.g. be prepared on the development or on the production of the field instrument. The instrument description file can in particular be manually prepared by a developer, with it being determined in this manner which parameters of the field instrument can be set and how they should be visualized. At least one parameterizable value of the field instrument and its visualization are therefore stored in the instrument description file. Furthermore, it can also be laid down in the instrument description file whether possible measured values of the field instrument are shown in the offline instrument simulation of the field instrument, for example in the form of randomly generated simulation values. It is thus possible e.g. to set and simulate measurement ranges, measured values, measurement intervals, measurement times and/or routines of different functions by means of the instrument simulation. For example, with a particle measuring instrument for flue gas analysis, the respective measurement interval and the respective measurement time for a specific particle size can be settable.

The instrument description file is in this respect present on a computer on which the instrument simulation is to be generated. On the generation of the instrument simulation, description files such as HTML files and/or scripts are, for example, generated which can be performed by the browser. The instrument simulation is preferably generated once during the development at the manufacturer's. The instrument simulation can contain all the data required for the offline simulation in the browser. Due to the generation of the instrument simulation on the basis of the instrument description file, the computer does not require any data connection to the field instrument, but can rather generate the instrument simulation solely on the basis of the instrument description file. This allows the offline instrument simulation.

Since no respective data connection to the field instrument to be simulated is necessary for the generation of the instrument simulation, a plurality of different instrument simulations of different field instruments can also be generated from the corresponding instrument description files and can be used, for example, for training purposes or in customer presentations. The instrument description file can also be changed in a simple manner on the development of field instruments to test different configurations of a future field instrument.

Advantageous embodiments of the invention are given in the description, in the drawing and in the dependent claims.

In accordance with an advantageous embodiment, the instrument description file is written in a markup language, in particular in XML (eXtensible Markup Language). The instrument description file can be platform-independent by the use of a markup language, i.e. it can be read by different operating systems such as Windows, Linux, Mac OS, and the like. The instrument simulation generated from the instrument description file can also be platform-independent.

The instrument description file can additionally also be used for so-called engineering tools which e.g. establish a data connection via serial interfaces to field instrument to parameterize them.

If, for example, XML is used as the markup language, a respective element for each measured value which can be determined by the field instrument can be provided in the instrument description file, wherein an attribute or a further element with the visualization provided for the respective measured value can be contained in the element. A separate element can likewise be provided in the instrument description file for each output (e.g. measured value output) and/or for each operating element of the field instrument.

For example, an instrument description file can be set up as follows in XML format:

```
<?xml version=“1.0” encoding=“UTF-8” standalone=“yes”?>
<device 1>
  <title>O2-Transmitter</title>
  <range>
    <start>0</start>
    <end>1000</end>
    <visualization>slider</visualization>
  </range>
  <measurement interval>
    <min>0</min>
    <max>400</max>
    <visualization>text</visualization>
  </measurement interval>
</device 1>
```

An O₂ transmitter, which covers a measurement range (“range”) from 0 to 1000 units and possible measurement intervals of 0 to 400 units, is described purely by way of example by the above instrument description file. The range is in this respect to be visualized as a slider and the measurement intervals are to be visualized as text in the instrument simulation.

The instrument simulation is preferably generated by means of a generator program from the instrument description file. The generator program can read in (i.e. “parse”) the instrument description file for this purpose and can generate the instrument simulation from the information contained in the instrument description file, wherein in particular the visualization of the settable parameters of the field instrument predefined in the instrument description file is implemented into a user interface by the generator program. The generator program can for this purpose make use of libraries in which specific visualizations of the settable parameters are stored. For example, the parameters can be set by means of sliders, rotary knobs, by text input and the like.

An instrument simulation which has been set once by the generator program and which was e.g. generated by the manufacturer of the field instrument can remain stored in this respect in order to be able to use it again and again. Different instrument simulations of different field instruments and/or different instrument description files can preferably be provided for customers centrally by a manufacturer. Alternatively, the instrument simulation can be prepared separately on each accessing of the instrument description file, whereby changes in the instrument description file which may have occurred in the meantime can be taken into account. The generator program can be configured as modular and flexible for this purpose such that different instrument description files of different field instruments can be realized in respective different instrument simulations.

The generator program is preferably matched to the required target format and/or to the computer platform used for carrying out the instrument simulation. A separate generator program can thus be prepared for each computer platform which takes account of specific demands of the respective computer platform.

In accordance with an advantageous embodiment of the invention, the instrument simulation comprises an HTML file (hypertext markup language file) and/or a CSS file (cascading style sheet file) and/or a JavaScript file and/or a flash file and/or an image file. The instrument simulation can furthermore also comprise video files, Java files and the like. The HTML file can in particular refer to the other named files and, for example, access a flash file when the HTML file is loaded by the browser. Instead of an HTML file, any other file format which can be interpreted by a browser can also be generated by the generator program.

Alternatively, the generator program can also generate a browser plug-in which is carried out by a browser and extends its function. The functional capability of the browser can be extended by the browser plug-in such that the instrument simulation can be visualized by the browser.

The instrument simulation can be carried out on the computer platform of the browser, whereby it is a web application carried out at the client side.

In accordance with a further advantageous embodiment, the files of the instrument simulation are packed in an archive file which is unpacked for carrying out the instrument simulation. The archive file can e.g. be present in the ZIP format, in the RAR format (Roshal archive) or as a self-extracting archive, for example as an executable EXE file. The generator program can therefore also generate an archive file instead of individual files and the archive file is then unpacked when the instrument simulation is to be carried out.

In accordance with a further advantageous embodiment, the files of the instrument simulation are locally stored. This means that the files of the instrument simulation are stored on the computer platform executing the browser.

In accordance with a further advantageous embodiment, the files of the instrument simulation are stored on a server and are accessed by the server. The computer executing the browser can alternatively or additionally access the files of the instrument simulation from the server if the computer has a data connection to the server.

In addition, the instrument simulation can be present as application software for mobile devices and/or as a browser plug-in. The generator program can alternatively or additionally generate the instrument simulation as application software for mobile devices (app) and/or as a browser plug-in, with all the instrument simulations generated by the generator program substantially having the same functional extent if they were generated on the basis of the same instruction description file. The instrument simulation can be present, for example, for the Android operating system, for the IOS operating system, for the Firefox browser, of the Chrome browser, etc.

A performed parameterization of the field instrument is preferably stored, in particular on a server and/or locally. The performed parameterization, i.e. the configuration settings, can be transferred to the server and stored there.

In accordance with a further advantageous embodiment, the performed parameterization is stored locally, e.g. by the browser's own mechanisms such as cookies, local storage or by means of a browser plug-in in a locally accessible memory. A stored parameterization can be reloaded on a later further use of the instrument simulation to continue or modify the parameterization.

If the instrument simulation is used, for example, for training purposes or at sales events, a performed parameterization is typically only stored or deleted again or discarded after use.

Alternatively, the performed parameterization is transferred to the field instrument. This can take place, for example, to test a performed parameterization at a real field instrument. For example, the parameterization can be stored on a USB memory stick and can be transferred to the field instrument by inserting the USB memory stick into the field instrument. The parameterization of the field instrument can be carried out in this manner without a direct data connection to the field instrument having to be present. If the parameterization stored on a USB memory stick is transferred sequentially to a plurality of field instruments, it can thus be ensured that all these field instruments work on the same basis of the same settings. This is in particular advantageous on an installation of new field instruments e.g. into an existing plant since the parameterization of the field instruments can already take place before their installation, i.e. offline.

The performed parameterization can selectively also be transferred to the field instrument via a direct data communication, for example via Ethernet, internet and/or field bus. The parameterization can equally be transferred to the field instrument via a serial interface of the field instrument, for example using an engineering tool.

Purely by way of example, an instrument simulation can therefore be generated in that an instrument description file is first prepared in which it is stored which parameters of the field instrument can be set and visualized. The instrument description file is subsequently implemented by means of a generator program, e.g. into an archive, with an HTML file and a JavaScript application being contained in the archive. The HTML file can refer to the JavaScript application, with the JavaScript application being carried out by accessing the HTML file in a browser and the instrument simulation being shown together with the HTML file. A user can access the instrument simulation in a browser and can use it to parameterize the field instrument according to his wishes. Changed parameters can be stored locally or on a server and can be transferred to the field instrument directly by means of a browser, for example, or by means of a USB memory stick for the actual changing of the parameterization of a real field instrument.

The invention will be described in the following purely by way of example with reference to the enclosed drawing. There are shown:

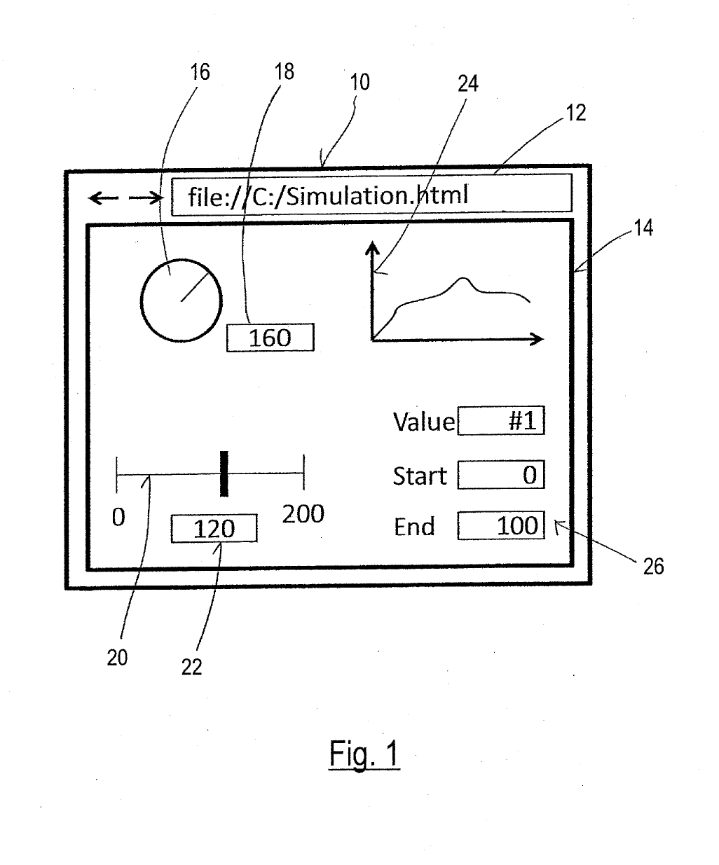

FIG. 1 a schematic representation of a user interface of an offline instrument simulation displayed by a browser;

A browser window 10 is shown schematically in FIG. 1, wherein a local HTML file (Simulation.html) is accessed in an address line 12 of the browser window 10 in which file an instrument simulation 14 is stored. The instrument simulation 14 represents a virtual representation of a field instrument (not shown), shows parameters of the field instrument and allows a change of the parameters shown.

The instrument simulation 14 comprises a visualized rotary knob 16 by means of which a measurement interval can be set in milliseconds, for example. The set measurement interval is displayed in a first text box 18.

A measurement range of the field instrument can be set by means of a slider 20, with a currently selected upper measurement range limit being shown in a second text box 22.

The instrument simulation 14 furthermore comprises the representation of a graph 24 in which simulated measured values of the field instruments are shown. The simulated measured values can e.g. be randomly generated by the instrument simulation 14 for the purpose of illustration.

The values shown in the graph 24 can be selected by a setting range 26 comprising three text boxes.

### REFERENCE NUMERAL LIST

10 browser window

12 address line

14 instrument simulation

16 rotary knob

18 first text box

20 slider

22 second text box

24 graph

26 setting range

1. A method of offline instrument simulation of a field instrument, wherein at least one parameter of the field instrument is visualized on a display unit and a parameterization of the field instrument is made possible and the instrument simulation (14) is generated on the basis of an instrument description file, and wherein the instrument simulation (14) is performed in a browser (10).

2. A method in accordance with claim 1,
characterized in that
the instrument description file is written in a markup language.

3. A method in accordance with claim 2,
characterized in that
the instrument description file is written in XML.

4. A method in accordance with claim 1,
characterized in that
the instrument simulation (14) is generated by means of a generator program from the instrument description file.

5. A method in accordance with claim 4,
characterized in that
the generator program is matched to the required target format and/or to the computer platform used for carrying out the instrument simulation (14).

6. A method in accordance with claim 1,
characterized in that
the instrument simulation (14) comprises an HTML file and/or a CSS file and/or a JavaScript file and/or a flash file and/or an image file.

7. A method in accordance with claim 6,
characterized in that
the files of the instrument simulation (14) are packed in an archive file which is unpacked for performing the instrument simulation (14).

8. A method in accordance with claim 1,
characterized in that
the files of the instrument simulation (14) are stored locally.

9. A method in accordance with claim 1,
characterized in that
the files of the instrument simulation (14) are stored on a server and can be accessed from the server.

10. A method in accordance with claim 1,
characterized in that
the instrument simulation (14) is present as application software for mobile devices and/or as a browser plug-in.

11. A method in accordance with claim 1,
characterized in that
a performed parameterization of the field instrument is stored.

12. A method in accordance with claim 11,
characterized in that
a performed parameterization of the field instrument is stored on a server and/or locally.

13. A method in accordance with claim 11,
characterized in that
the performed parameterization is stored by the browser's own mechanisms such as cookies, local storage or by means of a browser plug-in in a locally accessible memory.
